(19) United States
(12) Patent Application Publication
(10) Pub. No.: US 2022/0400243 A1
(43) Pub. Date: Dec. 15, 2022

(54) IMAGE PROCESSING APPARATUS AND IMAGE PROCESSING METHOD

(71) Applicant: CANON KABUSHIKI KAISHA, Tokyo (JP)

(72) Inventor: Ryota Shoji, Kanagawa (JP)

(21) Appl. No.: 17/837,157

(22) Filed: Jun. 10, 2022

(30) Foreign Application Priority Data
Jun. 15, 2021 (JP) 2021-099615
Mar. 9, 2022 (JP) 2022-036409

(51) Int. Cl. H04N 13/178; H04N 13/207

(52) U.S. Cl. CPC H04N 13/178; H04N 13/207

(57) ABSTRACT

An image processing apparatus determines whether an image represented by image data includes two circular areas and executes predetermined processing on the image if it is determined that the image includes two circular areas. The image processing apparatus can recognize if the image data is taken with a dual-eye lens even when an image capture apparatus that has recorded the image data has not recognized that a dual-eye lens unit has been attached and processing the image appropriately.

### BACKGROUND OF THE INVENTION

### Field of the Invention

Aspects of the present invention relate to an image processing apparatus and an image processing method.

### Description of the Related Art

Techniques are known which provide stereoscopic viewing by displaying parallax image pairs in a head-mounted display (HMD). In addition, Japanese Patent Laid-Open No. 2013-141052 describes an image capture apparatus capable of capturing a parallax image pair without using another apparatus, using a lens having one lens mount and two imaging optical systems (called a “dual-eye lens” hereinafter).

When a pair of images is formed on a single image sensor using a dual-eye lens having two imaging optical systems (a right eye optical system and a left eye optical system) whose optical axes distanced in the horizontal direction, the positional relationships between the imaging optical systems and the images are inverted horizontally. In other words, a captured image is obtained in which the image formed by the right eye optical system (the right image) is located on the left side and the image formed by the left eye optical system (the left image) is located on the right side.

In order to use the right image and the left image correctly, it is necessary to correctly understand the relationship between the right image and the left image in the captured image. This means that the image capture apparatus must be able to recognize that a dual-eye lens unit is mounted that forms an image in which the positional relationship between the right image and the left images is reversed.

For example, based on information about the lens unit (i.e., lens information) obtained through communication with the lens unit, the image capture apparatus may be able to recognize that the lens unit attached is a dual-eye lens unit that forms an image in which the positional relationship between the right image and left image is reversed. However, it is not always possible to obtain lens information from all lens units that can be attached to the image capture apparatus. It is also possible that the lens information does not contain information that enables a determination as to whether the lens unit installed is a dual-eye lens unit that forms an image in which the positional relationship between the right image and the left image is reversed.

### SUMMARY OF THE INVENTION

The present invention has been conceived in light of these problems with conventional techniques. The present invention in one aspect provides an image processing apparatus and an image processing method capable of recognizing if an image recorded by an image capture apparatus is taken with a dual-eye lens even when the image capture apparatus has not recognized that a dual-eye lens unit has been attached and processing the image appropriately.

According to an aspect of the present invention, there is provided an image processing apparatus comprising: one or more processors that execute a program stored in a memory and thereby function as: an obtaining unit configured to obtain image data; a determining unit configured to determine whether an image represented by the image data includes two circular areas; and a processing unit configured to execute predetermined processing on the image when determining unit determines that the image includes two circular areas.

According to another aspect of the present invention, there is provided an image processing method executed by an image processing apparatus, the image processing method comprising: obtaining image data; determining whether an image represented by the image data includes two circular areas; and executing predetermined processing on the image when it is determined that the image includes two circular areas.

According to a further aspect of the present invention, there is provided a non-transitory computer-readable medium storing a program that causes a computer, when executed by the computer, to function as an image processing apparatus comprising: an obtaining unit configured to obtain image data; a determining unit configured to determine whether an image represented by the image data includes two circular areas; and a processing unit configured to execute predetermined processing on the image when determining unit determines that the image includes two circular areas.

Further features of the present invention will become apparent from the following description of exemplary embodiments (with reference to the attached drawings).

### BRIEF DESCRIPTION OF THE DRAWINGS

FIGS. 1A and 1B are schematic diagrams illustrating an example of the configuration of an image processing system according to an embodiment.

FIGS. 2A and 2B are perspective views illustrating an example of the external appearance of a camera according to the embodiment.

FIG. 3 is a block diagram illustrating an example of the functional configuration of a camera according to the embodiment.

FIG. 4 is a cross-sectional view illustrating an example of the configuration of a dual-eye lens unit.

FIGS. 5A and 5B are schematic diagrams pertaining to a positional relationship between images formed by a single-eye lens unit and a dual-eye lens unit.

FIG. 6 is a block diagram illustrating an example of the functional configuration of a PC according to the embodiment.

FIG. 7 is a flowchart pertaining to operations of the camera according to the embodiment.

FIG. 8 is a flowchart pertaining to operations of the PC according to the embodiment.

FIG. 9 is a schematic diagram illustrating an example of the configuration of an image processing system according to another embodiment.

FIG. 10 is a flowchart pertaining to operations of the camera according to another embodiment.

FIG. 11 is a flowchart pertaining to operations of the PC according to another embodiment.

FIGS. 12A and 12B are schematic diagrams pertaining to operations performed in step S703 of FIG. 8.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Note that the following embodiments will describe a case where the present invention is applied in a personal computer. However, the present invention can be applied in any electronic device capable of processing images. Examples of such an electronic device include digital cameras, tablet computers, media players, PDAs, mobile phones, smartphones, game consoles, robots, drones, and dashboard cameras. These are merely examples, however, and the present invention can be applied in other electronic devices as well.

### First Embodiment

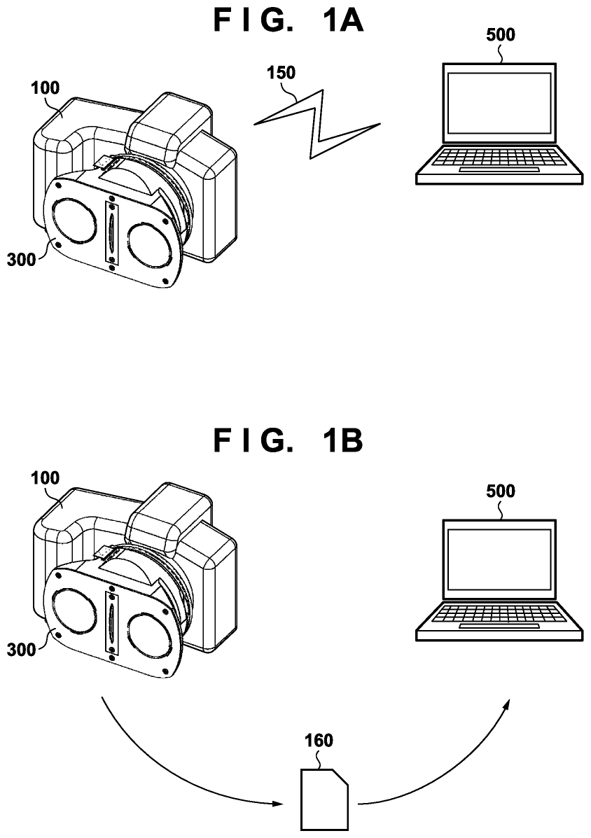

FIGS. 1A and 1B are schematic diagrams illustrating an image processing system including a personal computer (PC) 500 serving as an example of an image processing apparatus according to an embodiment of the present invention, and a digital camera 100 (“camera 100” hereinafter) that generates image data to be processed by the PC 500.

The camera 100 can obtain data of a captured image having a three-dimensional 180-degree visual field and a stereo 180-degree field of view (“VR image” hereinafter) using a dual-eye lens unit 300. Although the present embodiment assumes that the camera 100 is an interchangeable lens type, the camera 100 need not be an interchangeable lens type. In the present embodiment, the dual-eye lens unit 300 contains two imaging optical systems that form circular fisheye images having 180-degree visual fields. A virtual reality (VR) image having a three-dimensional effect can be played back using circular fisheye images having parallax. The configuration of the dual-eye lens unit 300 will be described in detail later.

The PC 500 is a common personal computer, and functions as the image processing apparatus of the present embodiment by executing application software. The PC 500 can obtain captured image data, obtained by the camera 100 executing image capture processing, directly from the camera 100 through wired or wireless communication 150 (see FIG. 1A). The PC 500 may also obtain the captured image data by loading captured image data recorded in a removable medium 160, which is a semiconductor memory card, for example, by the camera 100 (see FIG. 1B).

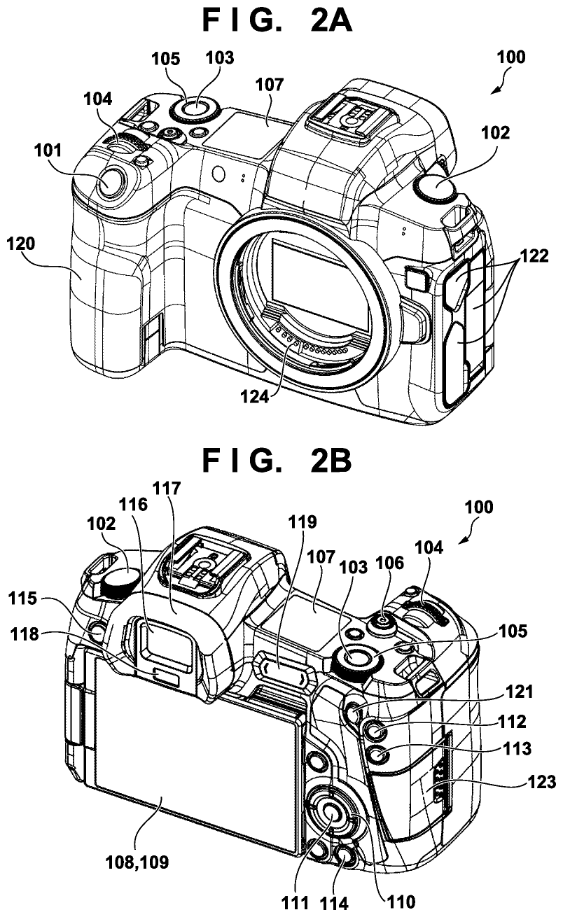

The configuration of the camera 100 will be described next. FIGS. 2A and 2B are perspective views illustrating an example of the external appearance of the camera 100. FIG. 2A is a perspective view of the front of the camera 100 from above at an angle, and FIG. 2B is a perspective view of the rear of the camera 100 from above at an angle.

The camera 100 has, on its top surface, a shutter button 101, a power switch 102, a mode changing switch 103, a main electronic dial 104, a sub electronic dial 105, a moving image button 106, and an on-body display unit 107. The shutter button 101 is an operation unit for performing shooting preparations or making a shooting instruction. The power switch 102 is an operation unit for switching the power of the camera 100 on and off. The mode changing switch 103 is an operation unit for switching among various types of modes. The main electronic dial 104 is a rotary operation unit for changing setting values such as shutter speed, aperture, and the like. The sub electronic dial 105 is a rotary operation unit for moving a selection frame (a cursor), moving through images, and the like. The moving image button 106 is an operation unit for instructing moving image shooting (recording) to start and stop. The on-body display unit 107 displays various setting values such as shutter speed, aperture, and the like.

The camera 100 has, on its rear surface, a display unit 108, a touch panel 109, a directional key 110, a SET button 111, an AE lock button 112, an enlarge button 113, a playback button 114, a menu button 115, an eyepiece part 116, an eye proximity sensing unit 118, and a touch bar 119. The display unit 108 displays images, various types of information, and the like. The touch panel 109 is an operation unit that detects touch operations made on a display surface (a touch operation surface) of the display unit 108.

The directional key 110 is an operation unit constituted by a key which can be depressed in the up, down, left, and right directions (a four-direction key). Operations can be made according to the position of the directional key 110 which has been depressed. The SET button 111 is an operation unit pressed mainly when confirming a selected item. The AE lock button 112 is an operation unit pressed when locking the exposure state in a shooting standby state. The enlarge button 113 is an operation unit for switching an enlarged mode on and off during live view display (LV display) in a shooting mode. Operating the main electronic dial 104 while the enlarged mode is on enlarges or reduces the live view image (LV image). Additionally, the enlarge button 113 is used to enlarged playback images in a playback mode, increase an enlargement rate, and so on.

The playback button 114 is an operation unit for switching between a shooting mode and the playback mode. Pressing the playback button 114 during the shooting mode causes a transition to the playback mode, and the newest image among images recorded in a recording medium 227 (described later) can be displayed in the display unit 108. The menu button 115 is an operation unit pressed when displaying a menu screen, in which various types of settings can be made, in the display unit 108. A user can make various types of settings in the camera 100 by operating the menu screen displayed in the display unit 108 using the directional key 110 and the SET button 111. The menu screen can be operated using the touch panel 109 instead of using buttons or in conjunction with the use of buttons.

The eyepiece part 116 is a window for looking into an eyepiece viewfinder (a look through-type viewfinder) 117. The user can view an image displayed in an internal electronic viewfinder (EVF) 217 (described later) through the eyepiece part 116. The eye proximity sensing unit 118 is a sensor that senses whether an object is near the eyepiece part 116.

The touch bar 119 is a bar-shaped touch-based operation unit (line touch sensor) capable of accepting touch operations. The touch bar 119 is disposed in a position where the user can make a touch operation (can touch) with their right thumb while holding a grip part 120 with their right hand (with the pinky, ring, and middle fingers of their right hand) in a state where the shutter button 101 can be depressed by the index finger of their right hand. In other words, the touch bar 119 can be operated in a state where the shutter button 101 can be depressed at any time (a shooting posture) while looking into the eyepiece viewfinder 117 through the eyepiece part 116. The touch bar 119 can accept a tap operation on the touch bar 119 (an operation of touching and releasing within a predetermined amount of time without moving the touched position), left and right slide operations (operations of touching and then moving the touched position while remaining in contact), and the like. The touch bar 119 is a different operation unit from the touch panel 109 and may have a display function. The touch bar 119 according to the present embodiment functions as a multi-function bar (an M-Fn bar).

The camera 100 also includes the grip part 120, a thumbrest part 121, a terminal cover 122, a lid 123, a communication terminal 124, and the like. The grip part 120 is a holding part formed in a shape which is easy for the user to grip with their right hand while holding the camera 100. The shutter button 101 and the main electronic dial 104 are disposed in positions which can be operated by the right index finger while the camera 100 is held by gripping the grip part 120 with the right pinky, ring, and middle fingers. The sub electronic dial 105 and the touch bar 119 are disposed in positions which can be operated by the right thumb in the same state.

The thumbrest part 121 (thumb standby position) is a grip part provided on the rear surface of the camera 100 at a location where it is easy to place the thumb of the right hand which is holding the grip part 120 while not operating any operation units. The thumbrest part 121 is constituted by a rubber member or the like to increase the holding power (the grip). The terminal cover 122 protects connectors such as connection cables that connect the camera 100 to external devices. The lid 123 protects the recording medium 227 (described later) and a slot for storing the recording medium 227 by covering the slot. The communication terminal 124 is a terminal for communication with a lens unit 200 (described later) which can be attached to and removed from the camera 100.

Internal Configuration of Camera 100

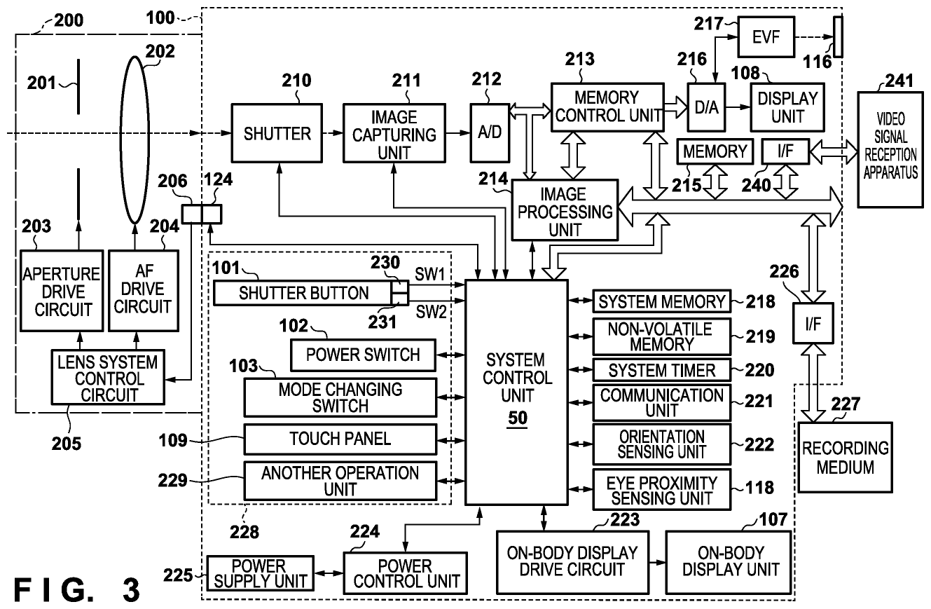

FIG. 3 is a block diagram illustrating an example of the internal configuration (the functional configuration) of a camera system in which an interchangeable lens unit 200 is mounted to the camera 100. In FIG. 3, the same reference signs as in FIGS. 2A and 2B are given to the elements also illustrated in FIGS. 2A and 2B. Descriptions of elements already described with reference to FIGS. 2A and 2B will be omitted as appropriate.

The lens unit 200 will be described first.

The lens unit 200 is an example of an interchangeable lens that can be attached to and removed from the camera 100. The lens unit 200 is a general single-eye lens (a lens having a single optical axis). The lens unit 200 includes an aperture stop 201, a lens 202, an aperture drive circuit 203, an AF (autofocus) drive circuit 204, a lens system control circuit 205, a communication terminal 206, and the like.

The aperture stop 201 is configured such that the diameter of the opening can be adjusted. The lens 202 is constituted by a plurality of lenses. The aperture drive circuit 203 adjusts an amount of light by controlling the diameter of the opening in the aperture stop 201. The AF drive circuit 204 drives a focus lens included in the lens 202 and adjusts the distance at which the lens unit 200 focuses.

The lens system control circuit 205 includes a CPU, ROM, and RAM, for example, and controls operations of the various units of the lens unit 200 by loading a program which is stored in the ROM into the RAM and executing the program using the CPU. The lens unit 200 and the camera 100 are electrically connected through the communication terminals 206 and 124, and the lens system control circuit 205 and a system control unit 50 included in the camera 100 can therefore communicate with each other. The lens system control circuit 205 controls the aperture drive circuit 203, the AF drive circuit 204, and the like based on the instructions from the system control unit 50.

The configuration of the camera 100 will be described next.

The camera 100 includes a shutter 210, an image capturing unit 211, an A/D converter 212, a memory control unit 213, an image processing unit 214, memory 215, a D/A converter 216, the EVF 217, the display unit 108, and the system control unit 50.

The shutter 210 is a focal plane shutter that operates based on instructions from the system control unit 50 and controls the exposure time of the image capturing unit 211. The image capturing unit 211 is an image sensor constituted by a CCD, a CMOS element, or the like that converts an optical image into an electrical signal. In the present embodiment, the image capturing unit 211 is an image sensor that supports autofocus using the image plane phase detection method (image plane phase difference AF). Specifically, the image capturing unit 211 is capable of outputting a focus detection signal pair to implement autofocus using the phase detection method.

The A/D converter 212 converts analog signals output from the image capturing unit 211 into digital signals (image data). The image processing unit 214 carries out predetermined processing (pixel interpolation, resizing processing such as reduction, color conversion processing, and the like) on data input through the A/D converter 212 or the memory control unit 213. The image processing unit 214 performs predetermined computational processing using shot image data to calculate evaluation values and the like used for AF, AE, and the like. Based on the obtained computational results, the system control unit 50 performs exposure control, focus detection control, and the like. A defocus amount based on the focus detection signal pair obtained from the image capturing unit 211 is also calculated by the image processing unit 214 as one of the evaluation values. Furthermore, the image processing unit 214 performs predetermined computational processing using the shot image data, and performs auto white balance (AWB) processing on the image data based on the obtained computational results.

Image data from the A/D converter 212 is written into the memory 215 through the image processing unit 214 and the memory control unit 213. Alternatively, image data from the A/D converter 212 is written into the memory 215 through the memory control unit 213 without going through the image processing unit 214. The memory 215 stores the image data output by the A/D converter 212 and image data generated by the image processing unit 214. The image data generated by the image processing unit 214 includes display image data for display in the display unit 108, the EVF 217, or the like, and recording image data for recording into the recording medium 227. The memory 215 has a storage capacity sufficient to store a predetermined number of still image data, a predetermined time's worth of moving image data and audio data, and so on. A partial region of the memory 215 is used as video memory for the display unit 108.

The D/A converter 216 converts the image data, stored in the memory 215, into an analog signal suitable for display in the display unit 108, the EVF 217, and the like. The display image data written into the memory 215 is therefore displayed by the display unit 108, the EVF 217, or the like via the D/A converter 216. The display unit 108 and the EVF 217 perform displays according to the analog signal from the D/A converter 216. The display unit 108 and the EVF 217 are, for example, LCD, organic EL, or similar displays.

While shooting moving images with the image capturing unit 211, image data stored in the memory 215 through the A/D converter 212 is converted into an analog signal by the D/A converter 216, and is then sequentially transferred to the display unit 108, the EVF 217, or the like and displayed. This makes it possible to perform live view display in the display unit 108, the EVF 217, or the like.

The system control unit 50 is a control unit constituted by at least one processor (CPU) and/or at least one circuit. In other words, the system control unit 50 may be a processor (CPU), a circuit, or a combination of a processor and a circuit. For example, if the system control unit 50 has a processor (CPU), the system control unit 50 controls the camera 100 as a whole by loading a program stored in non-volatile memory 219 into system memory 218 and executing the program using the processor. The system control unit 50 also performs display control by controlling the memory 215, the D/A converter 216, the display unit 108, the EVF 217, and the like.

The camera 100 also includes system memory 218, the non-volatile memory 219, a system timer 220, a communication unit 221, an orientation sensing unit 222, and the eye proximity sensing unit 118.

The system memory 218 is, for example, RAM. Operational constants and variables of the system control unit 50, programs read out from the non-volatile memory 219, and so on are loaded into the system memory 218.

The non-volatile memory 219 may be, for example, EEPROM that can be recorded to and erased electrically. Operational constants, programs, and the like of the system control unit 50 are recorded in the non-volatile memory 219.

The system timer 220 is a time measurement unit that measures times used in various types of control, measures the time of an internal clock, and so on. The communication unit 221 sends and receives image signals, audio signals, and the like to and from external devices connected wirelessly or over a hardwire cable. The communication unit 221 can also communicate with external devices compliant with wireless LAN (Local Area Network), with devices on the Internet, and so on. The communication unit 221 is also capable of communicating with external devices over Bluetooth (registered trademark). The communication unit 221 can transmit images shot by the image capturing unit 211 (including live images), images recorded in the recording medium 227, and the like, and can also receive image data and various other types of information from external devices.

The orientation sensing unit 222 outputs a signal representing the orientation of the camera 100 relative to the direction of gravity. Whether an image shot by the image capturing unit 211 is an image shot while the camera 100 was held horizontally or vertically can be determined based on a signal output by the orientation sensing unit 222. The system control unit 50 can add orientation information based on the signal output by the orientation sensing unit 222 to the image file of an image shot by the image capturing unit 211, record the image in a rotated state, and so on. An accelerometer, a gyrosensor, or the like can be used as the orientation sensing unit 222, for example. Based on the output signal from the orientation sensing unit 222, the system control unit 50 can also sense movement of the camera 100 (pan, tilt, lifting, whether the camera is at rest, and the like).

The eye proximity sensing unit 118 can sense the approach of an object to the eyepiece part 116 of the eyepiece viewfinder 117 that incorporates the EVF 217. For example, an infrared proximity sensor can be used for the eye proximity sensing unit 118. When an object is nearby, infrared light emitted from a light-emitting unit (not illustrated) of the eye proximity sensing unit 118 are reflected by the object and received by a light-receiving unit of the infrared proximity sensor. Whether or not there is an object that has approached the eyepiece part 116 can be determined by the amount of infrared light received.

The system control unit 50 switches the display unit 108 and the EVF 217 between displaying (a display state)/not displaying (a non-display state) in accordance with whether a nearby object has been sensed by the eye proximity sensing unit 118. Specifically, when the camera is at least in the shooting standby state and a display destination switch setting is set to auto switching, the display of the display unit 108 is turned on and the display of the EVF 217 is turned off while no nearby object is detected. If a nearby object is detected, the display of the EVF 217 is turned on and the display of the display unit 108 is turned off. Note that the eye proximity sensing unit 118 is not limited to an infrared proximity sensor, and other sensors may be used as long as the sensors can sense a state that can be considered eye proximity.

The camera 100 also includes the on-body display unit 107, an on-body display drive circuit 223, a power control unit 224, a power supply unit 225, a recording medium I/F 226, an operation unit 228, a video signal output I/F 240, and the like.

The on-body display unit 107 displays various setting values of the camera 100, such as shutter speed, aperture, and the like, through the on-body display drive circuit 223. The power control unit 224 is constituted by a battery detection circuit, a DC-DC converter, switch circuits for switching the blocks through which power passes, and so on, and detects whether or not a battery is connected, the type of the battery, the remaining battery power, and so on. The power control unit 224 also controls the DC-DC converter based on the detection results and instructions from the system control unit 50, and supplies a necessary voltage for a necessary period to the various units, including a recording medium 227. The power supply unit 225 is a primary battery such as an alkali battery, a lithium battery, or the like, a secondary battery such as a NiCd battery, a NiMH battery, a Li battery, or the like, an AC adapter, or the like. The recording medium I/F 226 is an interface for the recording medium 227 such as a memory card, a hard disk, or the like.

The recording medium 227 is a memory card or the like for recording shot images, and is constituted by semiconductor memory, a magnetic disk, or the like. The recording medium 227 may be removable or built-in. The video signal output I/F 240 is an interface for outputting image signals from the camera 100 to an external device. The video signal output I/F 240 includes one or more interfaces that comply with a standard. The standard is not particularly limited, and the interface may be compliant with the HDMI (registered trademark) standard, for example. For example, the camera 100 outputs moving image data being shot to an external device connected to the video signal output I/F 240 (a video signal receiving apparatus 241). The PC 500 in FIG. 1A corresponds to the video signal receiving apparatus 241.

The operation unit 228 is an input unit that accepts operations from the user (user operations), and is used to input various types of instructions to the system control unit 50. The operation unit 228 includes the shutter button 101, the power switch 102, the mode changing switch 103, the touch panel 109, other operation members 229, and the like. The other operation members 229 include the main electronic dial 104, the sub electronic dial 105, the moving image button 106, the directional key 110, the SET button 111, the AE lock button 112, the enlarge button 113, the playback button 114, the menu button 115, the touch bar 119, and the like.

The shutter button 101 has a first shutter switch 230 and a second shutter switch 231. The first shutter switch 230 turns on when the shutter button 101 is manipulated halfway, or in other words, is half-pressed, and generates a first shutter switch signal SW1. The system control unit 50 interprets the first shutter switch signal SW1 as a shooting preparation instruction and starts shooting preparation processing. The shooting preparation processing includes AF processing, AE processing, AWB processing, and flash pre-emission processing.

The second shutter switch 231 turns on when the shutter button 101 is completely manipulated, or in other words, is fully pressed, and generates a second shutter switch signal SW2. The system control unit 50 interprets the second shutter switch signal SW2 as a still image shooting instruction and starts still image shooting operations based on exposure conditions determined in the AE processing. Each unit is then controlled to execute a series of shooting processing from reading signals from the image capturing unit 211 to generating an image file containing the still image data obtained from shooting and writing the image file into the recording medium 227.

The mode changing switch 103 switches the operating mode of the system control unit 50 among a still image shooting mode, a moving image shooting mode, a playback mode, and the like. The still image shooting mode includes an auto shooting mode, an auto scene determination mode, a manual mode, an aperture priority mode (Av mode), a shutter speed priority mode (Tv mode), and a program AE mode (P mode). There are also various types of scene modes, custom modes, and the like as shooting settings for different shooting scenes. The user can directly switch to any of the shooting modes mentioned above using the mode changing switch 103. Alternatively, the user can selectively switch to any of a plurality of modes displayed by using the operation unit 228 after first switching to a shooting mode list screen using the mode changing switch 103. Likewise, the moving image shooting mode may include a plurality of modes.

The touch panel 109 is a touch sensor that detects various types of touch operations on the display surface of the display unit 108 (an operation surface of the touch panel 109). The touch panel 109 and the display unit 108 can be configured as an integrated unit. For example, the touch panel 109 is attached to an upper layer of the display surface of the display unit 108. By associating input coordinates on the touch panel 109 with the display coordinates on the display surface of the display 108, a GUI can be configured to make it seem that the user can directly manipulate screens displayed in the display unit 108. “GUI” is an acronym of “Graphical User Interface”. The touch panel 109 can use any of a variety of systems, including resistive film, electrostatic capacitance, surface acoustic wave, infrared, electromagnetic induction, image recognition, optical sensors, and the like. Depending on the type, a touch is sensed when contact is made with the touch panel 109, or a touch is sensed when a finger or pen has approached the touch panel 109, and either of these types may be used.

The system control unit 50 can detect the following operations or states on the touch panel 109.
A finger or pen that has not touched the touch panel 109 newly touching the touch panel 109, i.e., the start of a touch (called “touch-down” hereinafter).
A state in which a finger or pen is touching the touch panel 109 (called “touch-on” hereinafter).
A finger or pen moving while touching the touch panel 109 (called “touch-move” hereinafter).
A finger or pen that has been touching the touch panel 109 separating from the touch panel 109 (being released), i.e., the end of a touch (called “touch-up” hereinafter).
When nothing is touching the touch panel 109 (called “touch-off” hereinafter).

When a touch-down is detected, a touch-on is detected at the same time. A touch-on normally continues to be detected after a touch-down as long as no touch-up is detected. When a touch-move is detected, a touch-on is detected at the same time as well. Even if a touch-on is detected, a touch-move is not detected as long as the touched position does not move. A touch-off occurs after a touch-up has been detected for all fingers or pens that had been touching.

These operations/states, positional coordinates on the touch panel 109 where the finger or pen had been touching, and so on are communicated to the system control unit 50. The system control unit 50 determines what type of operation (touch operation) has been made on the touch panel 109 based on the communicated information. With respect to a touch-move, the movement direction of the finger or pen moving on the touch panel 109 can be determined based on changes in the positional coordinates, for each of a vertical component and a horizontal component on the touch panel 109. A slide operation is determined to have been performed if a touch-move of greater than or equal to a predetermined distance has been detected. If, while touching the touch panel 109, the finger or pen is quickly moved a given distance and then removed, the operation is called “flicking”. In other words, a “flick” is an operation of quickly flicking a finger on the touch panel 109. A flick is determined to have been performed if a touch-move of greater than or equal to a predetermined distance and at greater than or equal to a predetermined speed is detected and a touch-up is then detected (it can be determined that a flick occurred continuing from a slide operation). Furthermore, when a plurality of locations (two points, for example) are touched at the same time, and the touched positions are brought together, the touch operation is called a “pinch-in”, whereas when the touched positions are moved apart, the touch operation is called a “pinch-out”. Pinch-out and pinch-in are collectively referred to as pinch operations (or simply “pinching”).

Configuration of Multi-Eye Lens Unit

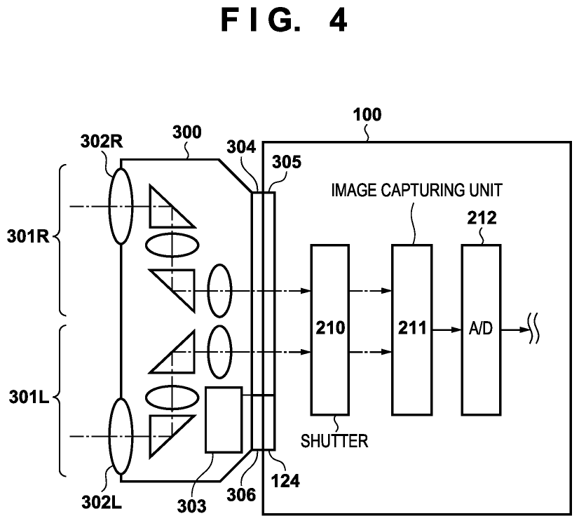

FIG. 4 is a schematic diagram illustrating an example of the configuration of a dual-eye lens unit 300 as an example of a multi-eye lens unit. The dual-eye lens unit 300 is a VR180 lens unit that forms a VR image compliant with the VR180 standard. In the present specification, “multi-eye lens” refers to a lens unit constituted by a plurality of imaging optical systems within a single lens mount (or lens barrel), and which has a plurality of optical axes. FIG. 4 illustrates the dual-eye lens unit 300 mounted to the camera 100. In FIG. 4, only part of the configuration of the camera 100 illustrated in FIG. 3 is illustrated.

The dual-eye lens unit 300 is a type of interchangeable lens that can be attached to and removed from the camera 100. The dual-eye lens unit 300 has two imaging optical systems 301L and 301R in one lens barrel, and thus has two optical axes.

Here, it is assumed that the two imaging optical systems 301L and 301R are arranged so that the two optical axes are aligned in a horizontal line when the dual-eye lens unit 300 is mounted on the camera 100. The two imaging optical systems 301L and 301R have a substantially 180-degree viewing angle and can capture an area of the front hemisphere. Specifically, the two imaging optical systems 301L and 301R can shoot a visual field of 180 degrees in the left-right direction (horizontal angle, azimuth angle, yaw angle) and 180 degrees in the up-down direction (vertical angle, elevation angle, pitch angle), respectively. The two imaging optical systems 301L and 301R form a pair of parallax images having left and right parallax on the image plane of the image capturing unit 211. In the following descriptions, the imaging optical system 301L will be called a left eye optical system 301L, and the imaging optical system 301R will be called a right eye optical system 301R.

The right eye optical system 301R and the left eye optical system 301L each has a plurality of lenses, reflective mirrors, and the like. The plurality of lenses include at least a focus lens for adjusting the focus distance. The dual-eye lens unit 300 also has a lens system control circuit 303. The right eye optical system 301R is an example of a first optical system and the left eye optical system 301L is an example of a second optical system. In the right eye optical system 301R and the left eye optical system 301L, respective lenses 302R and 302L located on the subject side face in the same direction, and the optical axes thereof are substantially parallel.

Although not illustrated in FIG. 4, the dual-eye lens unit 300 has a configuration similar to the AF drive circuit 204. In this case, an AF drive circuit that drives the focus lenses of the right eye optical system 301R and the left eye optical system 301L in tandem, and at least one AF drive circuit that drives the focus lens of at least one of the right eye optical system 301R and the left eye optical system 301L independently, can be provided. The focus lens is driven by the lens system control circuit 303 based on the control of the system control unit 50.

The dual-eye lens unit 300 further includes an encoder that detects a rotation amount and a rotation direction of a focus ring provided on the lens barrel. The lens system control circuit 303 controls the AF drive circuit according to focus lens operations detected by the encoder, and provides what is known as a “by wire” manual focus function. In this case, the dual-eye lens unit 300 may have a switch that enables the user to switch the focus lens driven by the focus ring operations.

The dual-eye lens unit 300 is a VR180 lens for shooting images in the VR180 format, which is a format of VR images that enables dual-eye stereoscopic viewing, using the camera 100. In the VR180 lens, the right eye optical system 301R and the left eye optical system 301L each has a fisheye lens having a substantially 180-degree viewing angle. The right eye optical system 301R and the left eye optical system 301L need only be able to obtain images that enable dual-eye VR display as VR180, and the viewing angle may be as low as 160 degrees. The VR180 lens can form a right image (a first image) using the right eye optical system 301R and a left image (a second image) using the left eye optical system 301L on the same image plane. It is assumed that the image capturing unit 211 of the camera 100 has one image sensor and that the dual-eye lens unit 300 forms the right image and the left image on the image plane of the one image sensor. However, the camera 100 may have two image sensors arranged in parallel, and the dual-eye lens unit 300 may form the right image on the image plane of one image sensor and the left image on the image plane of the other image sensor.

The dual-eye lens unit 300 includes a focus ring for adjusting the focus of the right eye optical system 301R and a focus ring for adjusting the focus of the left eye optical system 301L. Alternatively, a focus ring that simultaneously adjusts the focus of the right eye optical system 301R and the left eye optical system 301L, and a focus ring that adjusts the focus of one of the right eye optical system 301R and the left eye optical system 301L, are provided. By manipulating these focus rings, the user can manually adjust the focus distances of the right eye optical system 301R and the left eye optical system 301L. These focus rings may be provided individually or, in the case of a by-wire system, by switching the function of a single focus ring.

The dual-eye lens unit 300, like the (single-eye) lens unit 200, is attached to the camera 100 via a mount unit. The mount unit is constituted by a lens mount unit 304 and a camera mount unit 305. When the dual-eye lens unit 300 is mounted to the camera 100, the communication terminal 124 of the camera 100 is electrically connected to a communication terminal 306 of the dual-eye lens unit 300. This enables the system control unit 50 of the camera 100 and the lens system control circuit 303 of the dual-eye lens unit 300 to communicate with each other. However, the present embodiment assumes that the camera 100 cannot obtain, from the dual-eye lens unit 300, information which makes it possible to determine that the dual-eye lens unit 300 is a VR180 lens, that the positional relationship of the right image and the left image, which are circular fisheye images, is reversed, and so on. Information which makes it possible to determine that the dual-eye lens unit 300 is a VR180 lens may be, for example, circular fisheye center coordinates, a circular fisheye radius, or the like.

In the present embodiment, the right image and the left image are separated in the left-right direction and formed on the image plane of the image capturing unit 211. In other words, two optical images formed by the right eye optical system 301R and the left eye optical system 301L are formed on a single image sensor. The image capturing unit 211 converts the formed subject image (an optical signal) into an analog electrical signal. In this manner, by mounting the dual-eye lens unit 300, a parallax image pair (the right image and the left image) formed by the right eye optical system 301R and left eye optical system 301L can be obtained in a single shot. Additionally, by displaying the obtained right image and left image in VR as a right eye image and a left eye image, the user can view a three-dimensional VR image over a substantially 180-degree range, which is what is known as a “VR180 image”.

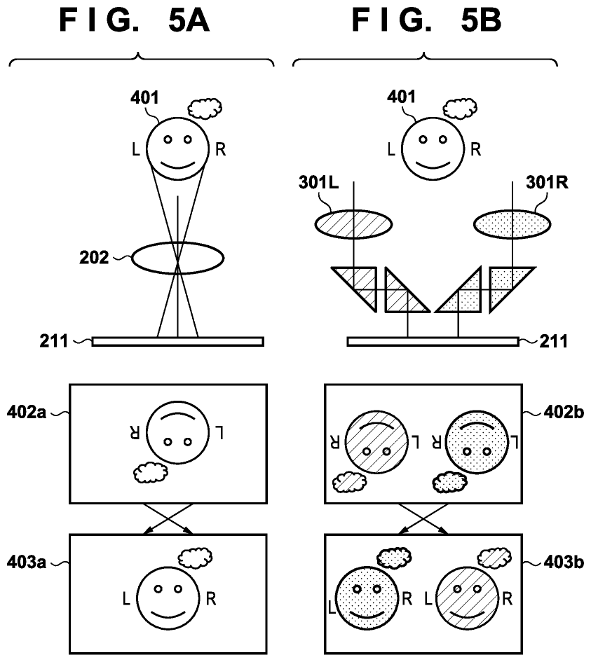

FIGS. 5A and 5B are schematic diagrams illustrating a subject image formed by the (single-eye) lens unit 200 and the dual-eye lens unit 300 in the image capturing unit 211. FIG. 5A illustrates the image formed by the (single-eye) lens unit 200, and FIG. 5B, the image formed by the dual-eye lens unit 300. It is assumed here that a scene in which a subject (a person's face) 401 is present in the center is shot. For convenience, the difference in the angle of view of the imaging optical system of each lens unit is ignored.

The subject image formed in the image capturing unit 211 by the (single-eye) lens unit 200 is an inverted normal image of the subject 401 (a normal image in which the top-bottom and left-right are reversed). Accordingly, rotating a captured image 402a by 180 degrees about the image center produces an image 403a in which the shooting scene and the subject 401 have the correct vertical and horizontal orientations.

On the other hand, the dual-eye lens unit 300 obtains a captured image 402b in which each of the left eye optical system 301L and the right eye optical system 301R forms an inverted normal image of the subject 401 in the image capturing unit 211. Rotating the captured image 402b by 180 degrees about the image center produces an image 403b. The format in which the circular fisheye images formed by the left eye optical system 301L and the right eye optical system 301R are recorded, as with the image 403b, is sometimes called the “mesh” format, while the format in which the two images are placed side by side on the left and right is sometimes called the “side-by-side” format. In the image 403b, the up-down and left-right orientations of the subject 401 are the same as in the shooting scene, but the positional relationship between the right image and the left image is reversed, with the subject image formed by the right eye optical system 301R (the right image) being on the left side and the subject image formed by the left eye optical system 301L (the left image) being on the right side. Accordingly, if the subject image on the right side of the image 403b is used as the right image and the subject image on the left side is used as the left image, the image cannot be displayed correctly.

If the camera 100 can recognize that the captured image includes the right image and the left image and that the positional relationship between the right image and the left image is reversed, the right image and the left image from the captured image can be used correctly if information pertaining to the right image and the left image is recorded in association with data of the captured image. However, if the camera 100 cannot recognize that the captured image includes the right image and the left image and that the positional relationship between the right image and the left image is reversed, information pertaining to the right image and the left image cannot be recorded in association with data of the captured image. The present embodiment makes it possible to correctly use the right image and the left image from the captured image even in such cases. This will be described in greater detail later.

Here, a “VR image” is an image that can be displayed in VR (described later). VR images include omnidirectional images (fulldome spherical images) shot by an omnidirectional camera (fulldome spherical camera), panoramic images that have a wider image range (effective image range) than the display range which can be displayed by a display unit at one time, and the like. VR images may be either still images or moving images. A moving image may be a pre-recorded moving image or a live image (an image obtained from a camera in near real-time).

A VR image has an image range (effective image range) equivalent to a visual field of up to 360 degrees in the left-right direction and 360 degrees in the up-down direction. VR images also include images that have a wider angle of view than can be shot a normal camera or a wider image range than the display range which can be displayed by a display unit at one time, even if the angle is less than 360 degrees in the left-right direction or 360 degrees in the up-down direction. The image shot by the camera 100 using the dual-eye lens unit 300 described above is a type of VR image. VR images can be displayed in VR, for example, by setting the display mode of a display device (a display device capable of displaying VR images) to “VR view”. By displaying VR images with a 360-degree angle of view in VR, the user can view omnidirectional images which are seamless in the left-right direction by changing the orientation of the display device in the left-right direction (a horizontal rotation direction).

Here, “VR display” (“VR view”) is a display mode that displays an image of a predetermined range of the visual field shot in the VR image according to the orientation of the display device. VR display includes “single-eye VR display” (“single-eye VR view”), in which a single image is displayed by applying a deformation that maps the VR image onto a virtual sphere (deformation in which distortion correction is applied). VR display also includes “dual-eye VR display” (“dual-eye VR view”), in which a left eye VR image and a right eye VR image are displayed side by side in left and right regions by performing a transformation or projection that maps those images onto a virtual sphere, respectively.

It is possible to view stereoscopic images by performing a “dual-eye VR display” using the left eye VR image and the right eye VR image, which have parallax with respect to each other. In any VR display, for example, when a user wears a display device such as a head-mounted display (HMD), the image is displayed in a visual field range corresponding to the direction in which the user's face is facing. For example, assume that at a given point in time, a VR image displays a visual field range centered at 0 degrees in the left-right direction (a specific heading, e.g., north) and 90 degrees in the up-down direction (90 degrees from the zenith, i.e., horizontal). If the orientation of the display device is flipped front-to-back from this state (e.g., the display surface is changed from facing south to facing north), the display range is changed to an image of a visual field range centered at 180 degrees in the left-right direction (the opposite heading, e.g., south) and 90 degrees in the up-down direction, of the same VR image. In other words, when the user turns their face from north to south (i.e., turns around) while wearing the HMD, the image displayed in the HMD is also changed from an image of the north to an image of the south.

Note that the VR image shot using the dual-eye lens unit 300 of the present embodiment is a VR180 format image of a range of substantially 180 degrees in the front, and there is no image of a range of substantially 180 degrees in the rear. If such a VR180 format image is displayed in VR and the orientation of the display device is changed to a side where the image is not present, a blank region, for example, is displayed.

By displaying VR images in this way, the user has a visual sense of actually being in the VR image (in a VR space). Note that the VR image display method is not limited to a method of changing the orientation of the display device. For example, the display range may be moved (scrolled) in response to a user operation made using the touch panel, a directional button, or the like. In addition to changing the display range by changing the orientation, the display range may be changed in response to a touch-move made on the touch panel, dragging operations using a mouse or the like, pressing a directional button, or the like during VR display (in the “VR view” display mode). Note that a configuration in which a display device such as a smartphone is attached to VR goggles (a head-mounted adapter) is a type of HMD.

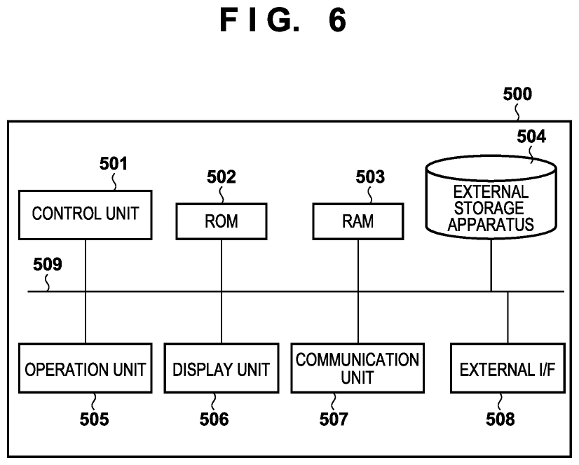

The PC 500 will be described next. FIG. 6 is a block diagram illustrating an example of the functional configuration of the PC 500. The PC 500 may be an electronic device commercially sold as a personal computer.

A control unit 501 is a processor capable of executing programs, and is a central processing unit (CPU), for example. Read-only memory (ROM) 502 is, for example, electrically rewritable non-volatile memory. The ROM 502 stores programs executed by the control unit 501, various types of setting values and parameters, and the like. Random access memory (RAM) 503 is used to load programs executed by the control unit 501, temporarily store various types of data, and the like. Part of the RAM 503 may be used as buffer memory, video memory, or the like.

An external storage device 504 is a mass storage device built into the PC 500. The external storage device 504 is typically a hard disk drive (HDD) or a solid-state drive (SSD). In addition to an HDD or an SSD, the external storage device 504 may include a storage device that includes a removable medium such as a memory card reader. An operating system (OS), application programs, user data, and the like are stored in the external storage device 504. Part of the external storage device 504 may be used as a memory swap region. Image data files obtained by being received from the camera 100, loaded from a memory card, or the like are stored in the HDD or the SSD of the external storage device 504.

“Operation unit 505” is a collective term for input devices which can be operated by a user, such as a keyboard, a mouse, a touch panel, and the like. A display unit 506 is, for example, a liquid crystal display (LCD), and may have a touch panel as well. The display unit 506 is used for the OS, applications, and the like running on the PC 500 to display various types of information, data, and the like.

A communication unit 507 has a communication circuit for communicating wirelessly with external devices, for example. The communication unit 507 is compliant with at least one wireless communication standard. Bluetooth (registered trademark), wireless LAN (IEEE 802.11x), and the like are common examples of wireless communication standards, but the standard is not limited thereto.

An external I/F 508 has a communication circuit for communicating over wires with external devices, for example. The external I/F 508 is compliant with at least one wired communication standard. Universal Serial Bus (USB), HDMI, Thunderbolt (registered trademark), Ethernet (registered trademark), and the like are common examples of wired communication standards, but the standard is not limited thereto.

A system bus 509 connects the above-described blocks so that the blocks can communicate with each other.

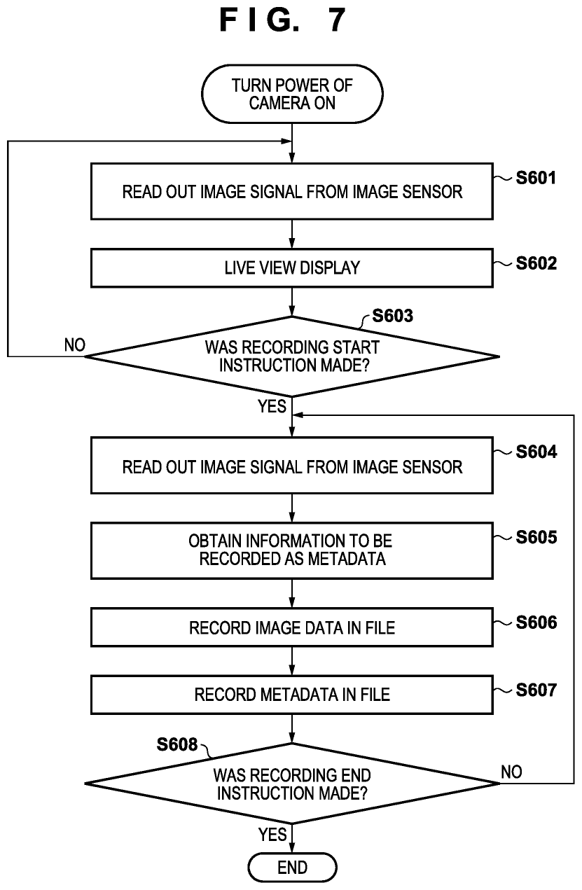

Shooting operations of the camera 100 will be described next with reference to the flowchart in FIG. 7. The shooting operations are realized by the system control unit 50 executing a program and executing necessary control. The shooting operations illustrated in FIG. 7 are started, for example, when the user turns the camera 100 on by operating the power switch 102. The system control unit 50 executes startup processing in response to the power being turned on, and then puts the camera 100 into a shooting standby state. It is assumed that in the shooting standby state, the camera 100 continuously shoots moving images and displays a live view display in the EVF 217 or the display unit 108.

In step S601, the system control unit 50 reads out an image signal equivalent to one frame of a moving image from the image capturing unit 211, and outputs the image signal to the A/D converter 212.

In step S602, the system control unit 50 causes the image processing unit 214 to generate image data for live view display. The image processing unit 214 stores the image data for live view display in a video memory region of the memory 215. The D/A converter 216 D/A converts the image data stored in the video memory region of the memory 215, and causes the converted data to be displayed in at least one of the EVF 217 and the display unit 108. The image processing unit 214 also generates evaluation values based on the image data and outputs the evaluation values to the system control unit 50. The system control unit 50 can determine exposure conditions, adjust the focus distance of the lens unit, and the like based on the evaluation values.

In step S603, the system control unit 50 determines whether the user has made a recording start instruction. The system control unit 50 can determine that a recording start instruction has been made upon detecting the second shutter switch signal SW2, for example. The system control unit 50 executes step S604 if it is determined that a recording start instruction has been made, and executes step S601 again for the live view display of the next frame if it is not determined that a recording start instruction has been made. In this manner, in the shooting standby state, the system control unit 50 continues to execute live view display operations until it is determined that a recording start instruction has been made. Note that the recording start instruction made be an instruction to start recording a moving image, made through the moving image button 106. Additionally, when an instruction aside from the recording start instruction is detected, the system control unit 50 executes operations in response to that instruction, but this will not be described in detail here.

In step S604, the system control unit 50 reads out an image signal from the image capturing unit 211, and outputs the image signal to the A/D converter 212. The system control unit 50 reads out a higher-resolution image signal than that read out during live view display, for example. The system control unit 50 causes the image processing unit 214 to generate image data for recording. The image processing unit 214 stores the image data for recording in the memory 215.

In step S605, the system control unit 50 obtains information to be recorded as metadata of the captured image data. The system control unit 50 can obtain shooting conditions (information pertaining to the settings and states of the camera 100 and the lens unit during shooting), parameters used in developing processing, and the like, for example. These are merely examples, and other information may be obtained instead. The shooting conditions can include, for example, exposure conditions such as shutter speed, aperture value, and ISO sensitivity; frame rate; resolution; data compression format; color space; gamma value; the orientation of the camera 100; whether the flash is on or off; and the like. In the case of moving image data, information indicating the frame start position in the moving image file is also included in the metadata. If lens information can be obtained from the lens unit, the lens information can also be included in the metadata. Other information not described in the examples here may also be recorded as metadata.

In step S606, the system control unit 50 records a data file, in which is stored the image data for recording generated by the image processing unit 214 in step S604, in the recording medium 227, for example.

In step S607, the system control unit 50 records the information obtained in step S605 as metadata of the image data, in association with the data file recorded in step S606. In the present embodiment, the metadata is recorded in the data file recorded in step S606.

In step S608, the system control unit 50 determines whether the user has made a recording end instruction. The system control unit 50 can determine that a recording end instruction has been made when the second shutter switch signal SW2 is not detected, for example. When shooting a moving image, the system control unit 50 can determine that a recording end instruction has been made upon detecting that the moving image button 106 has been operated, for example. The system control unit 50 ends the shooting operations if it is determined that a recording end instruction has been made. Note that the system control unit 50 may execute step S601 to return to the shooting standby state. If it is not determined that a recording end instruction has been made, the system control unit 50 returns to step S604 and executes shooting of the next frame of the moving image or a still image.

If the dual-eye lens unit 300 is mounted to the camera 100, a VR180 image (a still image or a moving image) is recorded in which two circular fisheye images are arranged on the left and right (in mesh or side-by-side format) and the left-right positional relationship of the circular fisheye images is reversed. Note that the data formats of the still image and the moving image are not particularly limited, and may be the RAW format, or a developed format (JPEG, MPEG, or the like). Note also that the captured image may be transmitted to the PC 500 through the video signal output I/F 240 instead of, or in addition to, being recorded in the recording medium 227. The PC 500 stores the image data file received through the communication unit 507 or the external I/F 508 in the external storage device 504.

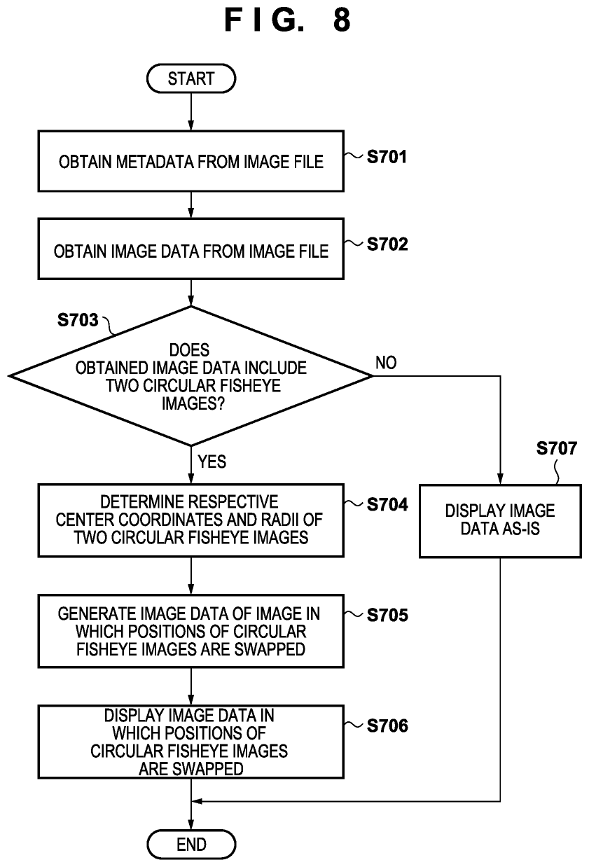

Image data display operations of the PC 500 will be described next with reference to the flowchart in FIG. 8. The operations described below are realized in the PC 500 by the control unit 501 executing an image processing application stored in the external storage device 504.

It is assumed here that the operations are started in response to the control unit 501 detecting that the user has selected an image data file to be processed using the operation unit 505 to operate a GUI presented by the image processing application in the display unit 506 and instructed processing to be executed. Note that the image data file to be processed is assumed to be selected from image data files stored in the external storage device 504 (an HDD, SSD, or a memory card), for example.

In step S701, the control unit 501 obtains, from the selected image data file, metadata pertaining to the image data in the file.

In step S702, the control unit 501 loads the image data to be processed from the image data file into the RAM 503, using the metadata obtained in step S701 as necessary.

In step S703, the control unit 501 (an image processing unit) determines the type of the image data loaded in step S702. Specifically, the control unit 501 determines whether the image data is data of an image including two circular fisheye images. This determination corresponds to determining whether the image data is VR image data in mesh format. In the case of an image including circular fisheye images, the peripheral areas aside from the circular fisheye images are black pixels. Accordingly, for example, the control unit 501 generates binary image data by applying a threshold close to the luminance value of black pixels to the luminance value of each pixel in the image data. Then, if it is determined that the image represented by the binary image data includes two white circular areas, the control unit 501 (a determining unit) determines that the type of the image data loaded in step S702 is data of an image including two circular fisheye images.

Whether the white areas are circular or not can be determined by any publicly-known method. For example, a plurality of any straight lines that intersect at two points on the perimeters of the white areas are drawn, and if perpendicular lines passing through the midpoint of each line intersect at a single point, the areas can be determined to be circular. However, in practice, taking error into account, the areas may be determined to be circular areas as long as intersecting points between a plurality of perpendicular lines are present within a set distance.

If two circular areas are detected, the control unit 501 may further determine whether the circular areas are the same size, and whether the distance between the circular areas is less than a threshold. If at least one of the conditions that the two circular areas are the same size and the distance between the circular areas is less than a threshold is met, the control unit 501 determines that the image data is VR image data including two circular fisheye images.

The two circular areas being the same size and the distance between the circular areas being less than a threshold are conditions that increase the likelihood of the image data being VR image data including two circular fisheye images. The size of a circular area may be, for example, the number of pixels within the area, or the maximum length of a straight line connecting two points on the perimeter of the area. If a difference between the number of pixels or the maximum length is less than a threshold, the two circular areas can be determined to have the same size. The distance between the circular areas may be a minimum distance between the perimeters of the two circular areas.

The image data may be determined to be VR image data including two circular fisheye images through a different method as well. For example, the control unit 501 divides the image data such that the image is divided into two areas, namely a left-hand area and a right-hand area. Then, for each area, the control unit 501 detects a partial area formed by pixels greater than or equal to a threshold. The control unit 501 determines whether the partial area is a circular area through the above-described method. If a circular area is detected in both the right-hand area and the left-hand area, the control unit 501 can determine that the image data is VR image data including two circular fisheye images. In this case, too, if at least one of the conditions that the two circular areas are the same size and the distance between the circular areas is less than a threshold, it may be determined that the image data is VR image data including two circular fisheye images.

The control unit 501 executes step S704 if it is determined that the image data being processed is data of an image including two circular fisheye images, and executes step S707 if not.

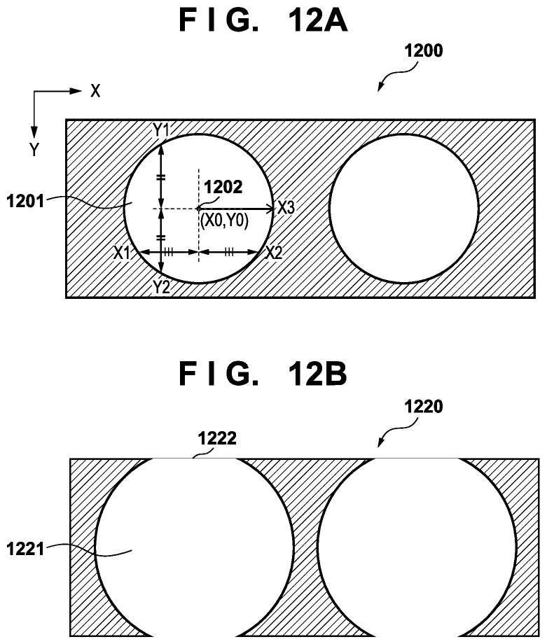

Note that if the effective pixel area of the image capturing unit 211 is small, an image 1220 may be recorded in which part of a subject image (circular fisheye image) 1221 formed by the right eye optical system 301R and the left eye optical system 301L is missing, as illustrated in FIG. 12B. Even if edge parts of the circular fisheye images are missing, a VR image can be displayed and reproduced by using central parts thereof. However, the viewing angle of the VR image will be narrower than when no parts of the circular fisheye image are missing.

If a white area 1221 reaches an edge part of the image 1220, whether the white area 1221 is part of the circular area can be determined through the above-described method, using a part of the image 1220, of the perimeter of the white area 1221, that does not form an edge part 1222. In other words, a plurality of any straight lines are drawn that intersect at two points including parts, of the perimeter of the white area 1221, that do not form the edge part 1222 of the image 1220, and if perpendicular lines passing through the midpoint of each line intersect at a single point, the white area 1221 can be determined to be part of the circular area. If the white area 1221 is determined to be part of the circular area, the image 1220 can be determined to include part of the circular fisheye image.

For example, if it is not determined that the image includes two circular fisheye images in step S703, the control unit 501 may further determine whether the image includes two circular fisheye images having missing parts. Then, if it is determined that the image includes two circular fisheye images having missing parts, the control unit 501 may execute the processing from step S704 on, assuming that the image includes two circular fisheye images. In this case, step S703 can be considered a determination as to whether the image data includes two at least partial circular fisheye images, and steps S704 to S706 can be considered processing performed on at least partial circular fisheye images.

In step S704, the control unit 501 determines center coordinates and radii of the two circular fisheye images included in the image. Because the perpendicular bisector of the chord of a circle passes through the center of the circle, any two lines can be drawn that intersect with two points on the circumference of the white area determined to be circular, and the intersecting point of the perpendicular bisectors of each line is the center coordinates of the white area.

A specific example will be described with reference to FIG. 12A. For example, for each of two circular areas 1201 detected from the data of an image 1200 in step S703, the pixel values in the horizontal direction are examined at a given vertical position (Y coordinate) to obtain an X coordinate X1 of a pixel that changed from black to white and an X coordinate X2 that changed from white to black. The pixel values in the vertical direction are also examined at a given horizontal position (X coordinate) to obtain a Y coordinate Y1 of a pixel that changed from black to white and a Y coordinate Y2 that changed from white to black. At this time, center coordinates 1202 (X0,Y0) of the circular area 1201 are (X1+X2)/2 for the X coordinate (X0) and (Y1+Y2)/2 for the Y coordinate (Y0). If the pixel values are examined in the horizontal direction from the center coordinates and the X coordinate of the pixel that changed from white to black is represented by X3, the radius of the circle is X3−((X1+X2)/2). The center coordinates are calculated, for example, as image coordinates with the origin at a point in the image (e.g., the image center). Note that for a circular area 1221 in which a part is missing, such as that illustrated in FIG. 12B, the center coordinates and the radius can be obtained in a similar manner using parts on the circumference excluding a part 1222 forming the edge part of the image.

The method described here is merely an example, and the center coordinates and radius of the circular fisheye image may be calculation through other image processing instead. Furthermore, taking error into account, average coordinates of the center coordinates obtained from each of a plurality of sets of two straight lines for a single circular area may be used as the final center coordinates. Similarly, the radius may be obtained by averaging the results for a plurality of directions calculated from the center coordinates.

In step S705, the control unit 501 (a generating unit) extracts two circular areas, corresponding to the right image and the left image, from the image data using the center coordinates and the radii of the two circular areas obtained in step S704. The control unit 501 may perform the extraction to include black areas in the periphery such that there are no parts missing from the circular areas. The control unit 501 then generates image data in which the left-right arrangement of the right image and the left image is swapped. Note that the control unit 501 arranges the images of the extracted circular areas such that the center coordinates of the left and right circular areas obtained in step S704 are retained even after the arrangement is swapped. For example, the circular area extracted from the left side of the image (the right image) is arranged such that the center coordinates thereof coincide with the center coordinates calculated for the circular area on the right side of the image (the left image). The same applies to the circular area extracted from the left side of the image.

Alternatively, if right eye coordinates and left eye coordinates in the image after the arrangement is swapped are known, the arrangement position of the right image may be determined based on the right eye coordinates, and the arrangement position of the left image may be determined based on the left eye coordinates.

In step S706, the control unit 501 displays the VR180 image data in which the arrangement of the circular fisheye images is swapped, generated in step S705, in the display unit 506, outputs the VR180 image data to a connected stereoscopic display device such as VR goggles through the communication unit 507 or the external I/F 508, or the like. Note that when displaying the VR180 image data and the like, the control unit 501 may convert the format from the mesh format to an equirectangular format by applying an equirectangular projection to the circular fisheye image as necessary.

In step S707, the control unit 501 displays the image data obtained in step S702 as-is in the display unit 506.

Although FIG. 8 illustrates the display operations as ending when steps S706 and S707 end, the processing may return to step S701 and stand by until another piece of image data is instructed to be processed. When the image data being processed is VR180 moving image data, the processing of steps S704 to S706 is repeated for each frame. For moving image data, the processing results of steps S703 and S704 for the first frame can be applied to the second and subsequent frames, and thus step S704 can be omitted from the processing on the second and subsequent frames.

Note that the user may be allowed to instruct whether to swap the arrangement of the right image and the left image at any timing from steps S704 to S706. If an instruction is made not to swap the arrangement, the control unit 501 displays the image data obtained in step S702 as-is. Note also that if it is determined in step S703 that the image does not include two circular fisheye images, it may be determined whether two circular fisheye images having missing parts are included. If it is determined that the image includes two circular fisheye images having missing parts, the processing from step S704 on may be applied to the circular fisheye images having missing parts.

Additionally, even if information as to whether the image data being processed is VR180 image data is not included in the metadata, a model name of the lens unit may be included in the metadata as general shooting information. In this case, by reading the model name of the lens unit in step S701 and referring to a VR180 lens model name list registered in advance, the type of the image data can be determined, i.e., whether the image data was shot using a VR180 lens can be determined. In this case, the determination of step S703 can be made without performing image processing. The control unit 501 may execute step S704 if the image data was shot using a VR180 lens, and may execute step S707 if the image data was shot using another lens.

The control unit 501 may also store at least one of the image data in which the arrangement of the right image and the left image is swapped, and image data in which the arrangement of the right image and the left image is swapped and an equirectangular projection is further applied to the right image and the left image, as a separate image file in the external storage device 504. This image data can be handled as-is by typical VR180-compatible devices such as VR goggles.

When this image data is stored separately, information indicating at least one of the image data being VR180 image data, the arrangement of the right image and the left image being swapped, and the equirectangular projection being applied can be recorded as metadata recorded in the image data file. This makes it possible to simplify the processing in a VR system which uses the image data.

The present embodiment assumes that the camera 100 cannot obtain information indicating that the dual-eye lens unit 300 is a VR180 lens from the dual-eye lens unit 300. If the camera 100 can determine that the dual-eye lens unit 300 is a VR180 lens based on information which can be obtained from the dual-eye lens unit 300, information indicating that the data is VR180 image data can be recorded in the image data file as metadata. This makes it possible for the PC 500 to make the determination of step S703 without performing image processing. The control unit 501 may execute step S704 if the image data was shot using a VR180 lens, and may execute step S707 if the image data was shot using another lens.

Furthermore, if the center coordinates, radii, and the like of the circular fisheye images (the right image and the left image) formed by the dual-eye lens unit 300 can be obtained from the dual-eye lens unit 300, this information can also be recorded in the image data file as metadata. If the information on the center coordinates, the radii, and the like of the circular fisheye images (the right image and the left image) is included in the metadata obtained in step S701, the control unit 501 can skip the processing of steps S703 and S704. Accordingly, the control unit 501 may determine whether the information on the center coordinates, the radii, and the like of the circular fisheye images (the right image and the left image) is included in the metadata obtained in step S701 prior to step S703 being executed. The control unit 501 then executes step S703 if it is determined that the information on the center coordinates, the radii, and the like of the circular fisheye images (the right image and the left image) is not included, and executes step S705 if it is determined that the information is included.

As described thus far, according to the present embodiment, when it is determined that the image data is data of an image including two circular fisheye images, the type of the image data is determined to be VR180 image data. Accordingly, even if whether image data is VR180 image data or not cannot be determined from metadata, the type of the image can be correctly recognized, and the data can be processed appropriately as VR180 image data. As such, even if the camera cannot recognize that the mounted lens unit is a VR180 lens, the camera can correctly recognize and appropriately handle the type of the image data recorded.

### Second Embodiment

A second embodiment of the present invention will be described next. A second embodiment relates to a configuration in which image signals read out from the image sensor are transmitted, in real time, as a video signal, from the camera 100 to which the dual-eye lens unit 300 is mounted to the PC 500. In the following descriptions, the same reference signs as in the first embodiment will be used for configurations that are the same as in the first embodiment, and descriptions thereof will be omitted.

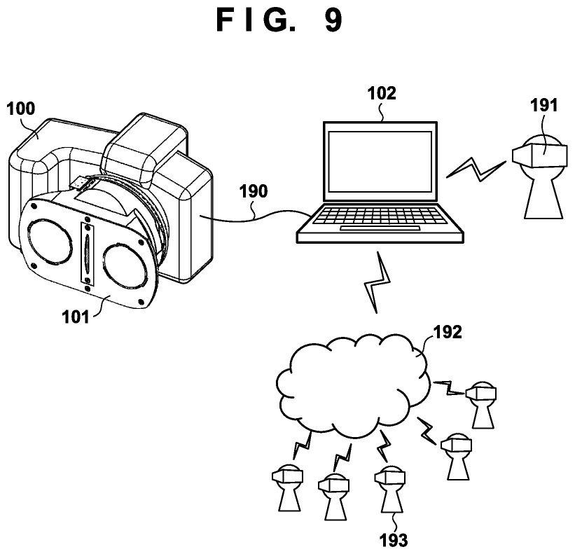

FIG. 9 is a schematic diagram illustrating an image processing system according to the second embodiment. The image processing system of the present embodiment has a configuration in which the camera 100 and the PC 500 are connected by a cable 190, and image signals read out from the image capturing unit 211 (the image sensor) of the camera 100 are transmitted to the PC 500 in real time. The cable 190 connects the video signal output I/F 240 of the camera 100 with the external I/F 508 of the PC 500, for example. It is assumed here, as an example, that the image signals are transmitted from the camera 100 to the PC 500 through a transmission method compliant with the HDMI standard. Accordingly, the video signal output I/F 240 and the external I/F 508 are interfaces compliant with the HDMI standard, and the cable 190 is an HDMI cable. However, the video signal may be transmitted according to another standard, such as Digital Visual Interface (DVI), SDI, USB Video Class, or the like.

The PC 500 can display the video signal received via the external I/F 508 in the display unit 506 in real time. The PC 500 can also convert the received video signal into a streamable format and transmit the signal to an HMD 191 connected to the PC 500, distribute the signal to a plurality of users 193 through a cloud service 192, or the like.

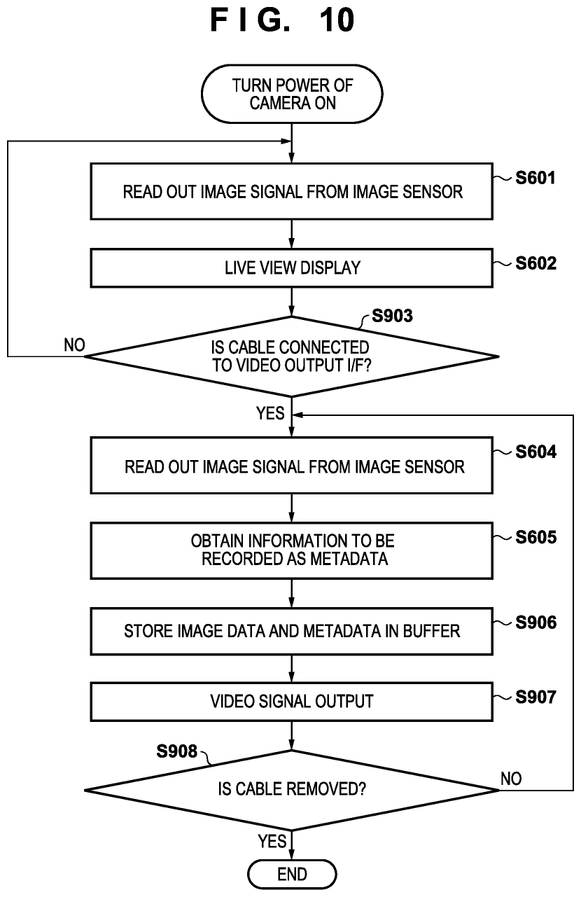

Video output operations by the camera 100 according to the present embodiment will be described next with reference to the flowchart in FIG. 10. In FIG. 10, steps that perform processing similar to the shooting processing described in the first embodiment are given the same reference signs as in FIG. 7, and will not be described. The video output operations are realized by the system control unit 50 executing a program and executing necessary control. The shooting operations illustrated in FIG. 10 are started, for example, when the user turns the camera 100 on by operating the power switch 102. The system control unit 50 executes startup processing in response to the power being turned on, and then puts the camera 100 into a shooting standby state.

It is assumed that in the shooting standby state, the camera 100 continuously shoots moving images and displays a live view display in the EVF 217 or the display unit 108 (steps S601 and S602).

In step S903, the system control unit 50 determines whether the cable 190 is connected to the video signal output I/F 240 based on a voltage on a signal line. The system control unit 50 executes step S604 if it is determined that the cable 190 is connected, and executes step S601 if not.

In step S604, the system control unit 50 reads out one frame's worth of an image signal, and causes the image processing unit 214 to generate display image data. In step S605, the system control unit 50 obtains information to transmit to the PC 500 as metadata. The present embodiment assumes that the system control unit 50 cannot obtain information which enables the dual-eye lens unit 300 to be determined to be a VR180 lens from the dual-eye lens unit 300.

In step S906, in parallel with operations for live view display in the camera 100, the system control unit 50 stores the image data and the metadata in a predetermined format in an HDMI signal output buffer prepared as a partial area of the memory 215, for example.

In step S907, the system control unit 50 outputs the image data and the metadata stored in the buffer through the video signal output I/F 240 as an HDMI signal. Encoding processing and the like for converting the data into an HDMI signal (TMDS sequence) will not be described in detail here.

In step S908, the system control unit 50 determines whether the cable 190 has been removed from the video signal output I/F 240 based on a voltage on a signal line. The video output operations end if it is determined that the cable 190 has been removed. The system control unit 50 repeats the processing from step S604 if it is not determined that the cable 190 has been removed. As a result, a live view image is continually displayed in the display unit 506 of the PC 500.

In the present embodiment, the dual-eye lens unit 300, which is a VR180 lens, is mounted to the camera 100. Accordingly, a video signal of an image which is a VR180 image including two circular fisheye images, and in which the positions of the right image and the left image are reversed (corresponding to the captured image 402b in FIG. 5B), is output to the PC 500. Note that the signal format of the image data output to the PC 500 may be the RGB format, the YCbCr format, or the RAW format. In the case of the RAW format, RAW data is stored in the buffer in step S906 instead of the display image data. Note that the display image data generated by the image processing unit 214 has a resolution matching the resolution of the display device in the camera 100. The image data for transmission to the PC 500 may have a resolution that takes into account the display resolution of the PC 500.

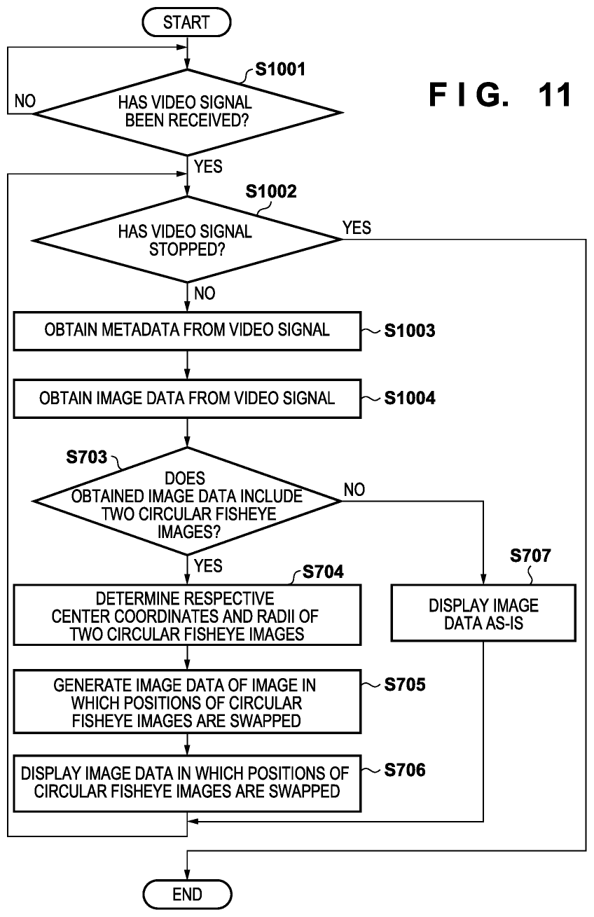

Video display operations of the PC 500 will be described next with reference to the flowchart in FIG. 11. The operations described below are realized in the PC 500 by the control unit 501 executing an image processing application stored in the external storage device 504. In FIG. 11, steps that perform processing similar to the image data display operations described in the first embodiment are given the same reference signs as in FIG. 8, and will not be described. It is assumed here that the external I/F 508 and the video signal output I/F 240 of the camera 100 are connected by the cable 190, and that the PC 500 is in a state capable of receiving a video signal from the camera 100.

In step S1001, the control unit 501 determines whether a video signal has been received through the external I/F 508. The control unit 501 executes step S1002 if it is determined that a video signal has been received, and executes step S1001 if not.

In step S1002, the control unit 501 determines whether or not the reception of the video signal through the external I/F 508 has stopped. The control unit 501 ends the video display operations if it is determined that the reception of the video signal has stopped, and executes step S1003 if not.

In step S1003, the control unit 501 decodes the received video signal and obtains the metadata.

In step S1004, the control unit 501 decodes the received video signal and obtains the image data.

Thereafter, the control unit 501 executes the processing of step S703 and on, described in the first embodiment.

Note that the user may be allowed to instruct whether to swap the arrangement of the right image and the left image at any timing from steps S704 to S706. If an instruction is made not to swap the arrangement, the control unit 501 displays the image data obtained in step S1004 as-is.

Additionally, in step S706, the image data may be displayed after being converted from the mesh format to an equirectangular format by applying an equirectangular projection to the right image and the left image of the image data in which the arrangement of the right image and the left image is swapped. Whether to display the mesh format or the equirectangular format may be instructible by the user.

Additionally, even if information as to whether the image data being processed is VR180 image data is not included in the metadata, a model name of the lens unit may be included in the metadata as general shooting information. In this case, by reading the model name of the lens unit in step S1003 and referring to a VR180 lens model name list registered in advance, the type of the image data being processed can be determined (i.e., whether the image data was shot using a VR180 lens). In this case, the determination of step S703 can be made without performing image processing. The control unit 501 may execute step S704 if the image data was shot using a VR180 lens, and may execute step S707 if the image data was shot using another lens.

Additionally, because the video signal received by the PC 500 in the present embodiment corresponds to moving image data, the processing results from steps S703 and S704 on the first frame can be applied to the second and subsequent frames as well. Step S704 can therefore be skipped for the second and subsequent frames.

Additionally, the image data converted from the mesh format to an equirectangular format by applying an equirectangular projection to the right image and the left image of the image data in which the arrangement of the right image and the left image is swapped may then be converted into a streamable format and supplied to the exterior. For example, the control unit 501 can transmit the image data in a streamable format to an HMD connected to the PC 500, transmit the image data to a distribution server via the communication unit 507 or the external I/F 508, and so on. This makes it possible to supply a live view image from the camera 100 to an external device, distribute the live view image to users in remote locations, and the like.

Additionally, the video signal received by the PC 500 may be converted into a streamable format as-is, and processing corresponding to steps S703 to S706 may be performed by an external device (a distribution server, an HMD, or the like).

The present embodiment assumes that the camera 100 cannot obtain information indicating that the dual-eye lens unit 300 is a VR180 lens from the dual-eye lens unit 300. However, if the camera 100 can determine that the dual-eye lens unit 300 is a VR180 lens based on information which can be obtained from the dual-eye lens unit 300, information indicating that the image data is VR180 image data can be included in the video signal as metadata. This makes it possible for the PC 500 to make the determination of step S703 without performing image processing. The control unit 501 may execute step S704 if the image data was shot using a VR180 lens, and may execute step S707 if the image data was shot using another lens.

Furthermore, if the center coordinates, radii, and the like of the circular fisheye images (the right image and the left image) formed by the dual-eye lens unit 300 can be obtained from the dual-eye lens unit 300, this information can also be recorded in the image data file as metadata. If the information on the center coordinates, the radii, and the like of the circular fisheye images (the right image and the left image) is included in the metadata obtained in step S1003, the control unit 501 can skip the processing of steps S703 and S704. Accordingly, the control unit 501 may determine whether the information on the center coordinates, the radii, and the like of the circular fisheye images (the right image and the left image) is included in the metadata obtained in step S1003 prior to step S703 being executed. The control unit 501 then executes step S703 if it is determined that the information on the center coordinates, the radii, and the like of the circular fisheye images (the right image and the left image) is not included, and executes step S705 if it is determined that the information is included.

As described thus far, according to the present embodiment, when image data transmitted as a video signal from the camera in real time is determined to be data of an image including two circular areas, the type of the image data is determined to be VR180 image data. Accordingly, even if whether image data is VR180 image data or not cannot be determined from metadata, the data can be processed appropriately as VR180 image data. As such, even if the camera cannot recognize that the mounted lens unit is a VR180 lens, the camera can correctly recognize and appropriately handle the type of the image data received.

### Other Embodiments

The operations described in the first embodiment with reference to the flowchart in FIG. 8 need not be executed by the PC 500, and may instead be executed by the camera 100. In other words, the image processing apparatus according to the first embodiment may be the camera 100.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2021-99615, filed on Jun. 15, 2021 and 2022-36409, filed on Mar. 9, 2022, which are hereby incorporated by reference herein in their entirety.

What is claimed is:

1. An image processing apparatus comprising:
one or more processors that execute a program stored in a memory and thereby function as:
an obtaining unit configured to obtain image data;
a determining unit configured to determine whether an image represented by the image data includes two circular areas; and
a processing unit configured to execute predetermined processing on the image when determining unit determines that the image includes two circular areas.

2. The image processing apparatus according to claim 1,
wherein the determining unit detects a circular area in each of a right-hand area and a left-hand area of the image.

3. The image processing apparatus according to claim 1,
wherein the determining unit determines that the image includes the two circular areas if a difference between sizes of the two circular areas detected from the image being less than a threshold and/or a distance between the two circular areas being less than a threshold.

4. The image processing apparatus according to claim 1,
wherein the predetermined processing is generating data of an image in which positions of the circular areas included in the image represented by the image data are switched.

5. The image processing apparatus according to claim 4,
wherein switching the positions of the circular areas is swapping the two circular areas between left and right.

6. The image processing apparatus according to claim 4,
wherein the processing unit saves the data of the generated image in association with metadata indicating a predetermined type.

7. The image processing apparatus according to claim 4,
wherein the processing unit further generates data of an image by applying an equirectangular projection to the data of the image in which the positions of the circular areas are switched.

8. The image processing apparatus according to claim 1,
wherein the obtaining unit obtains the image data from an image capture apparatus in real time.

9. The image processing apparatus according to claim 1,
wherein the obtaining unit further obtains metadata of the image data, and
if it is determined that the image data is of a predetermined type based on the metadata, the determining unit does not perform the determination.

10. The image processing apparatus according to claim 1,
wherein the processing unit executes the predetermined processing based on an instruction from a user.

11. The image processing apparatus according to claim 1,
wherein the circular areas included in the image are circular fisheye images.

12. The image processing apparatus according to claim 1,
wherein the image processing apparatus is an image capture apparatus that generates the image data through image capture processing.

13. The image processing apparatus according to claim 12,
wherein the image processing apparatus is an interchangeable lens-type image capture apparatus.

14. The image processing apparatus according to claim 1,
wherein the determining unit determines that the image includes two circular areas if it is determined that two at least partial circular areas are included.

15. An image processing method executed by an image processing apparatus, the image processing method comprising:
obtaining image data;
determining whether an image represented by the image data includes two circular areas; and
executing predetermined processing on the image when it is determined that the image includes two circular areas.

16. A non-transitory computer-readable medium storing a program that causes a computer, when executed by the computer, to function as an image processing apparatus comprising:
an obtaining unit configured to obtain image data;
a determining unit configured to determine whether an image represented by the image data includes two circular areas; and
a processing unit configured to execute predetermined processing on the image when determining unit determines that the image includes two circular areas.
